(19) United States
(12) Patent Application Publication
(10) Pub. No.: US 2020/0272100 A1
(43) Pub. Date: Aug. 27, 2020

(54) SYSTEMS AND METHODS FOR CONTROLLING ELECTROMAGNETIC RADIATION

(71) Applicant: THE TRUSTEES OF COLUMBIA UNIVERSITY IN THE CITY OF NEW YORK, New York, NY (US)

(72) Inventors: Nanfang Yu, Fort Lee, NJ (US); Adam Overvig, Bronx, NY (US); Sajan Shrestha, New York, NY (US)

(73) Assignee: THE TRUSTEES OF COLUMBIA UNIVERSITY IN THE CITY OF NEW YORK, New York, NY (US)

(21) Appl. No.: 16/791,618

(22) Filed: Feb. 14, 2020

Related U.S. Application Data
(63) Continuation of application No. PCT/US2018/046947, filed on Aug. 17, 2018.
(60) Provisional application No. 62/546,951, filed on Aug. 17, 2017.

(51) Int. Cl. G03H 1/04

(52) U.S. Cl. CPC G03H 1/0443; G03H 2240/13; G03H 2226/11; G03H 2223/20; G03H 2223/15; G03H 2222/31

(57) ABSTRACT

Systems and methods for controlling optical amplitude and phase of incident electromagnetic are provided, wherein an exemplary system comprises a substrate and a plurality of meta units, attached to the top surface of the substrate and configured to convert the incident electromagnetic radiation into a target electromagnetic radiation by modifying both optical amplitude and phase.

### CROSS-REFERENCE TO RELATED APPLICATIONS

This application is a continuation of International Patent Application No. PCT/US2018/046947, filed on Aug. 17, 2018, which claims priority to U.S. Provisional Application Ser. No. 62/546,951, filed on Aug. 17, 2017, which are incorporated by reference herein in their entirety.

### STATEMENT REGARDING FEDERALLY FUNDED RESEARCH

This invention was made with government support under FA9550-14-1-0389 awarded by the Air Force Office of Scientific Research Multidisciplinary University Research Initiative (AFOSR MURI) and HR0011-17-2-0017 awarded by Defense Advanced Research Projects Agency (DARPA). The government has certain rights in this invention.

### BACKGROUND

Holography is a technique for creating two-dimensional (2D) or three-dimensional (3D) images. Certain holography techniques involve recording the interference of a reference laser beam and scattered light from a real object. Certain metasurfaces have a flat layer, which can be thinner than the operating wavelength of light, and an optical scatterer, which can be smaller than the wavelength of light. Since metasurfaces can control the phase of the outgoing light wave in order to achieve the desired function (e.g., focusing, deflecting), certain metasurfaces can be utilized to generate computer generated holography by encoding a calculated complex transmission function onto a surface. However, both phase and amplitude control of light can be desired to obtain high-fidelity and high-resolution images. Furthermore, a unit cell basis with arbitrary combination of amplitude and phase can be necessary for wavefront control. While the phase control can be achieved with design principles, certain techniques fail to control both phase and amplitude.

There remains a need for techniques and systems for creating metasurface holograms with amplitude and phase control.

### SUMMARY

The presently disclosed subject matter provides systems and methods for controlling an electromagnetic radiation.

In certain embodiments, an example system for controlling an optical amplitude and an optical phase of electromagnetic radiation includes a substrate and one or more meta units attached to the top surface of the substrate. The meta units can convert incident electromagnetic radiation into target electromagnetic radiation by altering both optical phase and amplitude of the electromagnetic radiation.

In certain embodiments, each of the plurality of meta-units can have a different degree of birefringence and/or rotation angle to form a dielectric metasurface. The optical amplitude can be altered by modifying a degree of the birefringence, and the optical phase can be altered by modifying a degree of the orientation angle. In some embodiments, the range of the degree of the orientation angle can be from about 0° to about 180°. In some embodiments, the optical phase and the optical amplitude can be independently controlled by the system at optical frequencies. An example system can simultaneously alter the optical amplitude and the optical phase of electromagnetic radiation at multiple wavelengths (e.g., up to three wavelengths).

In certain embodiments, incident electromagnetic radiation can be a circularly polarized electromagnetic radiation of one handedness. The electromagnetic radiation can be circularly polarized in either the left or right directions. The disclosed system can convert the circularly polarized electromagnetic radiation into the target electromagnetic radiation with a predetermined polarization state. In some embodiments, an example system can include a filter which can the target electromagnetic radiation and absorb a non-target electromagnetic radiation.

In certain embodiments, the system can generate a two- or a three-dimensional holographic image. An example substrate can include a complementary metal oxide semiconductor (CMOS) compatible material such as amorphous silicon.

The disclosed subject matter also provides methods for controlling an optical amplitude and an optical phase. In some embodiments, a method includes providing a substrate with a plurality of meta-units attached on a top surface of the substrate, providing electromagnetic radiation on a bottom surface of the substrate, and filtering a target electromagnetic radiation to remove a non-target electromagnetic radiation, such that the meta units can convert the electromagnetic radiation into the target electromagnetic radiation. In some embodiments, the optical phase and the optical amplitude of incident electromagnetic radiation can be altered by modifying a geometry parameter of the meta units.

In certain embodiments, the method can further include modifying a degree of a birefringence angle of the plurality of meta-units to control the optical amplitude. In some embodiments, the method can further include modifying a degree of an orientation angle of the plurality of meta-units to control the optical phase. In non-limiting embodiments, the method can further include generating a holographic image, wherein the holographic image can be a two- or a three-dimensional holographic image.

### BRIEF DESCRIPTION OF THE FIGURES

FIG. 1A provides geometrical parameters of exemplary meta-units. FIG. 1B illustrates an exemplary unit cell. FIG. 1C shows a schematic of an example characterization of an amplitude-phase hologram.

FIG. 2A provides a top-view of an exemplary meta unit showing its geometrical parameter. FIG. 2B provides a scattering efficiency of the disclosed meta-unit. FIG. 2C provides a conversion efficiency from LCP to RCP of the disclosed meta-unit. FIG. 2D provides a device contour plots showing full ranges of conversion from LCP to RCP while maintaining scattering efficiency. FIG. 2E provides recorded amplitude plots of the exemplary output RCP light. FIG. 2F provides recorded phase plots of the exemplary output RCP light. FIG. 2G provide amplitude-phase graphs for desired ranges of Wy. FIG. 2H provides amplitude-phase graphs for desired ranges of α.

FIGS. 3A and 3F show the required amplitude and phase due to summation of dipole sources propagated from a distance D=100 μm to the metasurface plane. FIGS. 3B and 3G provides optical images of fabricated holograms. FIGS. 3C and 3H provide scanning electron microscope images of exemplary meta-units. FIGS. 3D and 3I provide exemplary reconstructed holograms at an observation angle of 0°. FIGS. 3E and 3J provide exemplary reconstructed holograms at observation angles of 10° and 15°.

FIG. 4A provides amplitude at the disclosed metasurface plane as calculated by interfering dipole sources. FIG. 4B provides phase at the disclosed metasurface plane as calculated by interfering dipole sources. FIG. 4C provides an exemplary reconstructed coil at three depths, showing the 3D nature of the coil. FIG. 4D provides an exemplary reconstructed coil at varying observation angles with approximate focal planes for reference.

FIG. 5A provides a 3D object by simulating a holographic recording. FIG. 5B illustrates a calculated amplitude for the 3D reconstruction. FIG. 5C provides a calculated phase for the 3D reconstruction. FIG. 5D provides simulated reconstruction by interfering dipoles emitted by the metasurface with amplitudes and phases given in FIGS. 5B and 5C. FIG. 5E shows a reconstructed hologram with a diode laser. FIG. 5F provides a reconstructed hologram with a light emitting diode (LED).

FIG. 6 provides wavelength dependence of 2D holography comparing phase and amplitude (PA, top row) to phase only (PO, bottom row) holograms for four selected wavelengths.

FIG. 7A shows an exemplary fabrication process flow. FIG. 7B illustrates exemplary metasurface.

FIG. 8 provides exemplary geometrical classes composing the disclosed final library.

FIG. 9 illustrates a schematic of the evolution of light through a birefringent meta-unit.

FIG. 10A provides an exemplary output polarization state, visualized by the Poincaré sphere. FIG. 10B shows an exemplary map of a predicted intensity. FIG. 10C shows an exemplary map of a predicted longitude. FIG. 10D shows an exemplary map of a predicted latitude. FIG. 10E shows an exemplary map of a simulated intensity by the disclosed meta-unit library. FIG. 10F shows an exemplary map of a simulated longitude by the disclosed meta-unit library. FIG. 10G shows an exemplary map of a simulated latitude by the disclosed meta-unit library.

FIGS. 11A-11B show constructed optimal choice of (FIG. 11A) W_{y} and (FIG. 11B) α for each desired amplitude and phase combination. FIG. 11C provides absolute values of the difference in the target phasor and the closest achievable phasor.

FIG. 12 shows a schematic of optical setup for optical reconstruction of holographic scenes at various observation angles.

FIG. 13A provides an exemplary reconstructed holographic image produced by the phase and amplitude hologram. FIG. 13B provides an exemplary holographic image produced by the phase-only hologram.

FIG. 14A provides a schematic of an exemplary building block of the disclosed dielectric metasurface hologram. FIGS. 14B and 14C show Forward scattering efficiency and conversion efficiency as a function of Wx and Wy at λ=1550 nm. FIG. 14D provides scattering efficiency and conversion efficiency plots of the disclosed system. FIGS. 14E and 14F illustrate maps of amplitude and phase of the converted light by the disclosed meta-units at varying orientation angles, α.

FIG. 15A provides an exemplary SEM image of a fabricated PO hologram. FIG. 15B shows an exemplary near-infrared image generated by PA holograms. FIG. 15C illustrates an exemplary near-infrared image generated by PO holograms.

FIG. 16 provide amplitude and phase of an exemplary final state.

FIG. 17 provides exemplary implementation of a device employing the unit cell library achieved. (Left column) Amplitude and phase of a computer-generated hologram. (Middle column) Look-up table for the geometric parameters need to supply any amplitude/phase combination. (Right column) Resulting map of device geometry, to be fabricated using CMOS-compatible nanofabrication techniques.

FIG. 18A provides an exemplary dark-field optical image of a metasurface hologram. FIG. 18B illustrates (Right) a reconstructed holographic image using phase and (Left) a reconstructed holographic image using both amplitude and phase.

FIG. 19A provides a simulation of holographic reconstruction of a 3D holographic cow. FIG. 19B shows an example holographic reconstruction of the 3D holographic cow with a laser diode at λ=1,550 nm.

FIGS. 20A-20B show exemplary example reconstruction of the 3D holographic cow with LED excitation at (FIG. 20A) −20 deg and (FIG. 20B) 20 deg.

FIG. 21 shows exemplary multiplexing sub-sets of the full library.

FIG. 22 illustrates (Left) a phase-dispersion diagram, (Middle) problem plots, and (Right) solution plots.

FIG. 23 provides a two-wavelength amplitude and phase control (Left) without geometric phase being used, (Middle) With geometric phase. (Right) The set of 10×10 boxes represent the phase-phase map for blue and red light.

FIG. 24 provides a two-wavelength amplitude and phase control (Left) without geometric phase being used, (Right) With geometric phase. Insets illustrates a set of 10×10 boxes which represents the phase-phase map for blue and red light. Markers indicate type of meta-unit in disclosed final meta-unit library. Handedness of input and output states of each color are chosen to be opposite each other (Right inset).

FIG. 25 shows exemplary two-color holograms. A two-color target image (Left) can be used to calculate the required amplitude and phase at two wavelengths of light (Right).

FIG. 26 provides exemplary two-color hologram reconstruction. A two-color target image (Top) is reconstructed by a tunable laser system at each wavelength separately (Middle) and combined to create a final image (Bottom).

Throughout the figures, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments.

### DETAILED DESCRIPTION

The presently disclosed subject matter provides techniques for controlling an optical amplitude and a phase of electromagnetic radiation. The disclosed techniques provide for modifying a wavefront of electromagnetic radiation by simultaneously or independently controlling an amplitude and a phase at optical frequencies. The disclosed techniques can be used for computer generated holography allowing stable reproduction of both phase and amplitude of a target holographic scene without iterative algorithms.

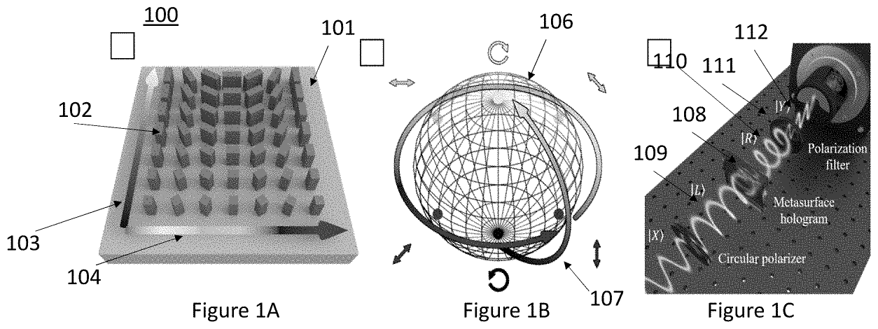

In certain aspects, the presently disclosed subject matter provides a system for controlling an optical amplitude and phase of electromagnetic radiation. Referring to FIG. 1A, an example system can include a substrate 101 and one or more meta units 102. The meta units can be attached to the top surface of the substrate to form a metasurface 100 which can transform an incident electromagnetic radiation into a target electromagnetic radiation.

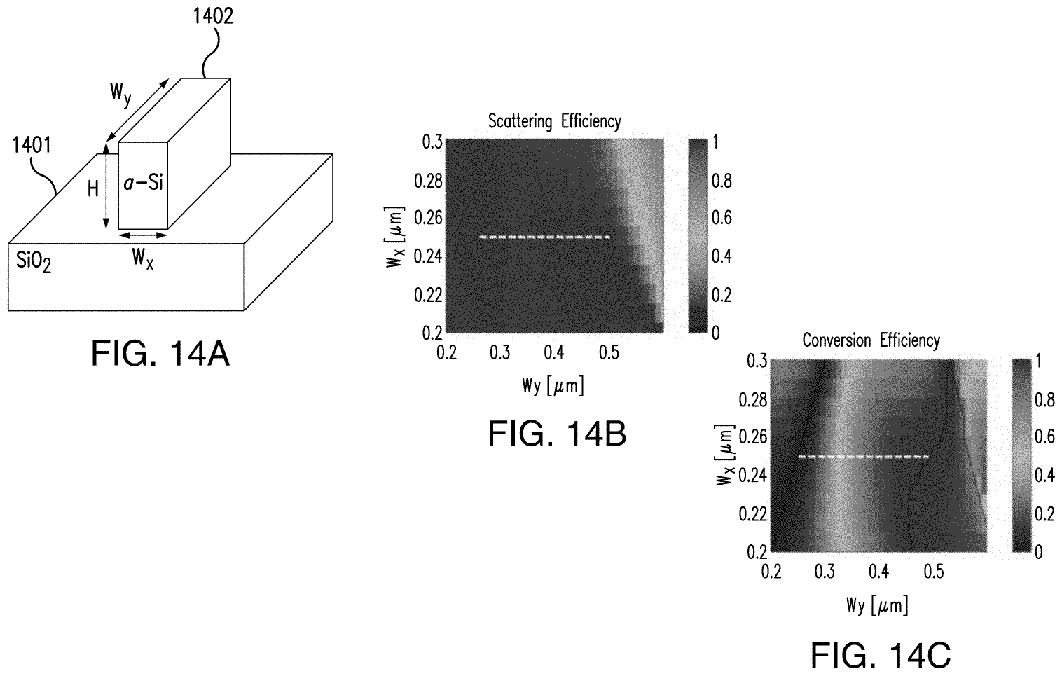

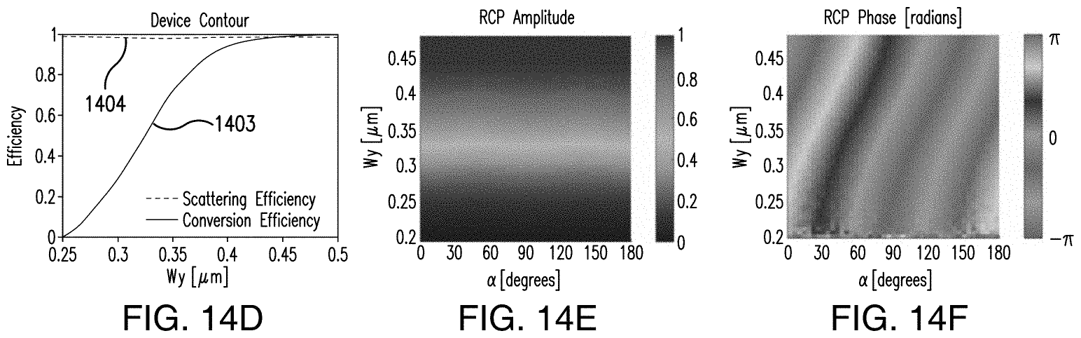

In certain embodiments, an exemplary meta unit can convert an electromagnetic radiation into a target electromagnetic radiation when the electromagnetic radiation comes from the bottom surface of the substrate or the meta-unit. For example, as shown in FIG. 1A, the disclosed meta-units 102 with a varying degree of form birefringence and rotation angles can create dielectric metasurfaces 100 that can alter wavefront of the incident electromagnetic radiation by controlling optical amplitude and phase. In some embodiments, the amplitude can be controlled by the degree of form birefringence, while the phase can be controlled by the degree of rotation angles. The amplitude can be solely dependent on the sine term, which depends in particular on the degree of birefringence of the meta-unit, as will be further explained below in connection with FIG. 14. The phase can be defined as a sum of the propagation phase,

$$\frac{{k}_{0} d ( {n}_{o} + {n}_{e} )}{2} ,$$

and the geometric phase 2α,
where k₀ is free-space wavevector,

$${k}_{0} = \frac{2 π}{λ} ,$$

λ is a corresponding wavelength, d is a height of the metal unit, nₒ and nₑ are effective refractive indices. Birefringence of the meta-unit can be defined as nₒ−nₑ, and α can be the rotation angle. In some embodiments, both amplitude and phase can be independently controlled by the disclosed system.

In certain embodiments, the disclosed metasurface can convert an incident electromagnetic radiation into any polarization state. The state at the output of the metasurface can be an elliptically polarized state with designed position on the Poincare sphere. As shown in FIG. 1B, an example converting process are visualized on the Poincare sphere 105. For example, the birefringence of the meta-unit can determine the “latitude” 106 of the output state on the Poincaré sphere, while the rotation angle α can determine the “longitude” 107 on the Poincaré sphere. By modifying degrees of the birefringence and/or the rotation angle of the meta-unit, incident electromagnetic radiation can be converted into any polarization state on the Poincaré sphere. In some embodiments, the incident electromagnetic radiation can be a circularly polarized electromagnetic radiation of one handedness (e.g., a right circularly polarized radiation or a left circularly polarized radiation). The circularly polarized electromagnetic radiation of one handedness can be converted to an electromagnetic radiation with the opposite direction of handedness (e.g., left 1402 to right 1403) by the disclosed system.

In certain embodiments, the disclosed system can further include a polarization filter. The polarization filter can selectively allow the target radiation to pass though the filter and block non-target radiation. For example, as shown in FIG. 1C, an example metasurface 108 can convert a left circularly polarized (LCP) electromagnetic radiation 109 to a right circularly polarized (RCP) radiation 110. The RCP component of the transmission through the metasurface can be selected by a polarization filter 111 and converted into linearly polarized light 112, while the remaining unconverted LCP can be filtered out. With the addition of a polarization filter (selecting for RCP radiation and absorbing the remaining LCP radiation), the output state on the Poincaré sphere can be mapped to amplitude and phase of the RCP light.

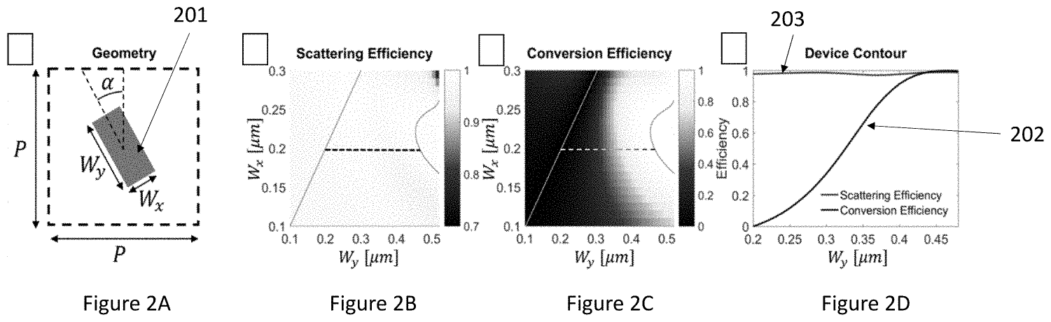

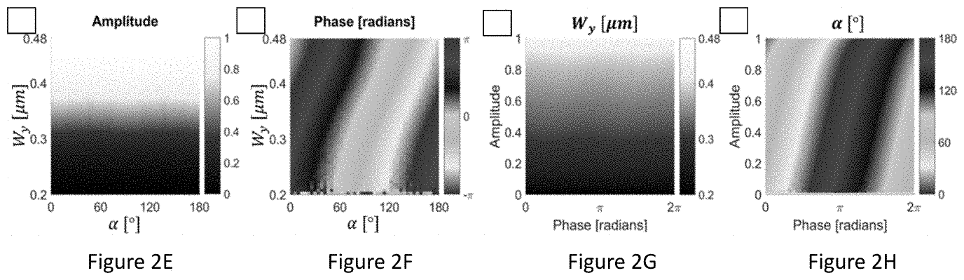

FIG. 2 provide exemplary full-wave simulations showing optical performance of the disclosed meta-units. FIG. 2A illustrates a top-view of an example meta-unit 201 showing its geometrical parameters. The example meta unit can have various geometrical parameters. For example, Wₓ and W_{y} can be in a range from about 0.1 μm to 0.5 μm. α can be in a range from 0° to 180°. The meta-unit can have a height in a range from about 0.1 μm to about 1 μm. In some embodiments, an example meta unit can have λ=1.55 μm, α=0 and the meta-unit height, d=800 nm. An example meta unit can be placed in a square lattice with spacing period of the metasurface (e.g., period of the metasurface (P)=650 nm). Scattering efficiency and conversion efficiency (from LCP to RCP) of the exemplary meta unit are shown in FIGS. 2B and 2C. A contour plots in FIG. 2D shows that the example meta unit can cover the full range of conversion 202 from LCP to RCP while maintaining high scattering efficiency 203 (>95%) by varying W_{y} and fixed Wₓ=200 nm (dashed lines in 2B and 2C). FIGS. 2E and 2F provide the amplitude and phase of the output RCP radiation in a range of W_{y} (from 0 μm to 0.48 μm) and α (From 0° to 180°), and the amplitude (e) and phase (f) of output RCP light are recorded. The results of FIGS. 2E and 2F can be inverted into look-up tables where for a given desired amplitude and phase, the required W_{y} (g) and α (h) can be found. The look-up tables can be used to identify required geometrical parameters for the complete and independent control over the two wavefront parameters simultaneously.

As used herein, the term “about” or “approximately” means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value.

In certain embodiments, the disclosed metasurface can generate a holographic image. FIG. 1C schematically depicts an example process of reconstructing a Phase and Amplitude (PA) holographic image: linearly polarized incident light can be converted by a quarter-wave plate to LCP light 109; the wavefront can be then modified by the PA holographic metasurface; the RCP component of the transmission through the metasurface 108 can be selected by a polarization filter 111 and converted into linearly polarized light 112, while the remaining unconverted LCP is filtered out. In certain embodiments, the holographic image can be generated by controlling phase, amplitude, or combinations thereof of electromagnetic radiation though the disclosed system. For example, to generate the 2D image, a target image can be discretized into dipole sources with amplitudes of 1 (corresponding to the inside area of the target image) and 0 (corresponding to the background), and uniform phase. The interference of these dipole sources can be recorded at a predetermined (e.g., distance D=100 μm) from the target image, which corresponds to the location of the metasurface that can reconstruct this target image. As such, both the phase and amplitude of the desired holographic image can be reproduced without an iterative algorithm to manipulate the phases of the dipoles in order to achieve uniform amplitude.

In certain embodiments, the holographic images generated by the disclosed metasurface can be optically reconstructed. For example, electromagnetic radiation from a tunable telecommunications diode laser can be sent to a circular polarizer, and then to the metasurface. The scattered light can be collected with a near-infrared objective and then passed through a polarization filter and an iris (to clean up the signal) before arriving at the sensor arrays of a near-infrared camera.

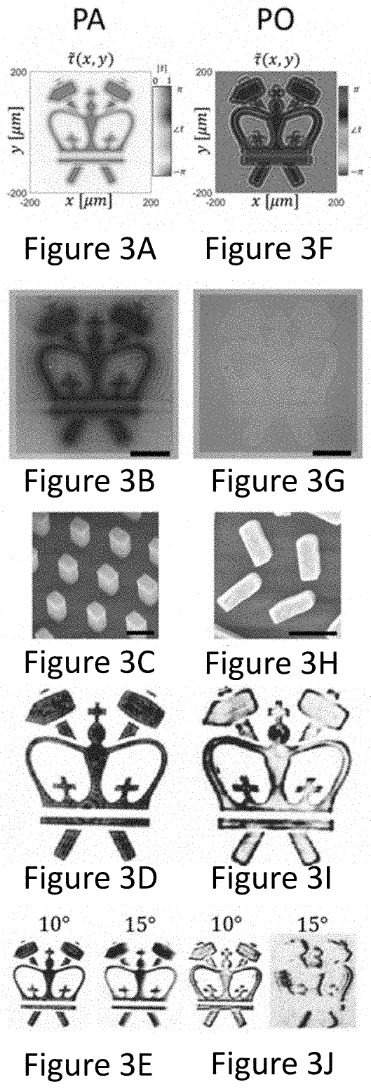

In certain embodiments, the holography generated by the disclosed metasurface can be a Phase-Amplitude (PA) image or a Phase-Only (PO) image. PA images can be generated by the metasurface with varying geometrical properties such as a shape, a size, a height, an orientation angle, and combinations thereof. PO images can be generated by the metasurface with varying an orientation angle. FIG. 3 illustrates comparison of exemplary PA and PO holographic images generated by the disclosed system. FIGS. 3A and 3F show the required amplitude and phase due to summation of dipole sources propagated from a distance D=100 μm to the metasurface plane. FIGS. 3B and 3G provide optical images of fabricated holograms. Scale bars are 100 nm. As shown in FIGS. 3C and 3H. the difference in contrast can be induced by the varying size of silicon meta-units in the metasurface for PA images and constant size in the metasurface for PO images. In some embodiments, the PA implementation reconstructs the target image with improved fidelity compared to the PO implementation. For example, as shown in FIGS. 3D-3J, both the uniformity within the target area and the contrast of the entire image can be improved.

In certain embodiments, the disclosed system can generate holographic images which can provide improved resolution against deterioration at oblique observation angle. For example, PA holographic images generated by the disclosed system can have mean-squared error (MSE) values corresponding to 3307 and 4611 at observation angles of 10° and 15° (FIG. 3E), while PO reconstruction at the same angles, with MSE values corresponding to 7985 and 16552.

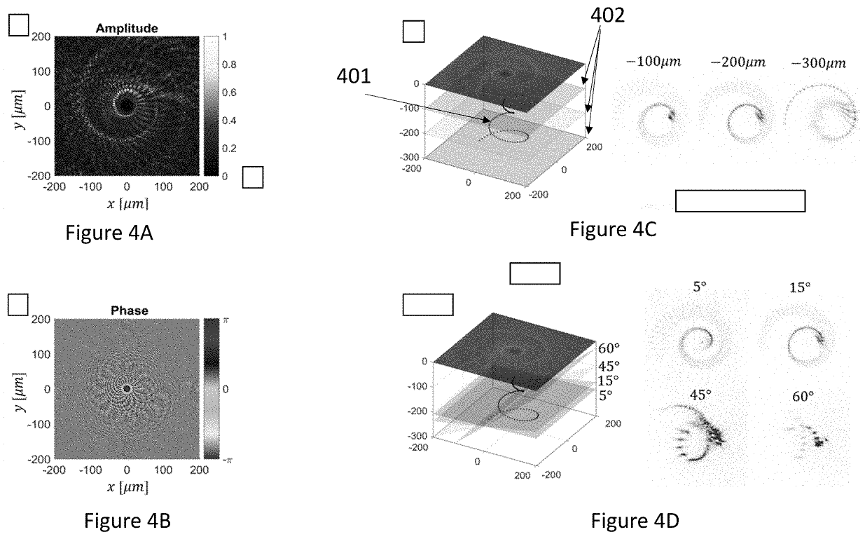

In certain embodiments, the disclosed metasurface can generate a three-dimensional holographic image. A 3D coil 401 can be calculated by discretization of the coil into an array of dipole sources and recording their interference at the metasurface plane using parameters such as amplitude and phase as shown in FIGS. 4A and 4B. To show the depth of the 3D coil, three focal planes 402 can be chosen for reconstruction, depicted in FIG. 4C. For example, the individual dipole sources can be discernible at the farthest focal plane of 300 μm, where in the target image the distribution of the dipoles can be sparsest, while at the nearest focal plane of 100 μm, they can be nearly continuous, and so a solid curve is observed. As seen in FIG. 4D, parallax can be demonstrated by changing the viewing angle of the camera (keeping normal incident angle of light onto the metasurfaces), with a recognizable image observed at an angle as high 60° (approximate corresponding focal planes are drawn in FIG. 4D).

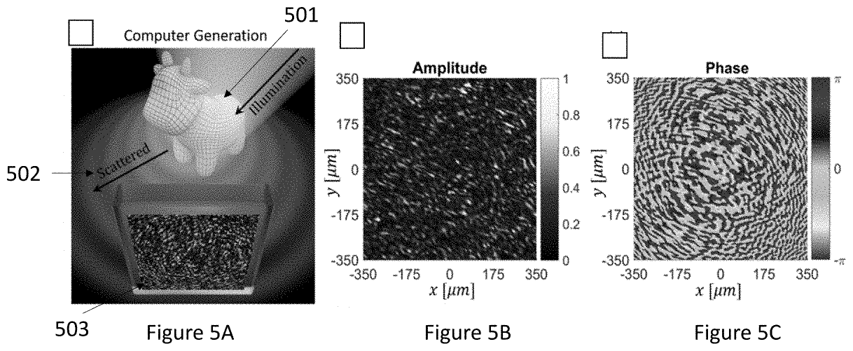

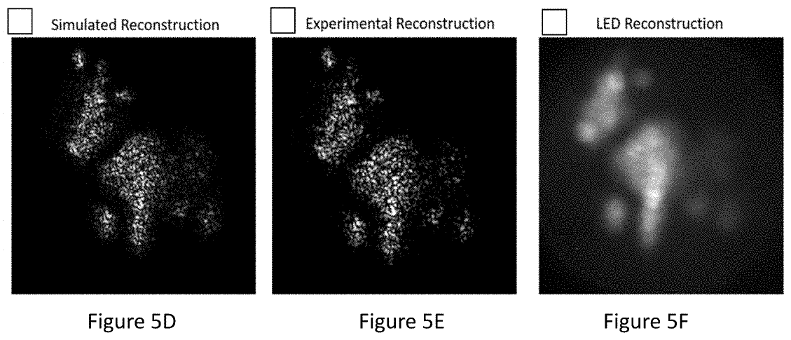

In certain embodiments, a target 3D-model can be converted into a hologram and then reconstructed. Exemplary 3D holograms are shown in FIG. 5. FIG. 5A depicts the computer generation of the hologram, computed with a simulation interfering light waves scattered off 502 the 3D surface of the cow 501. The generated image can include realistic physical effects such as occlusion which cannot be present in the 2D holography and a rough surface (simulated by choosing a random distribution of scattered phase over the surface of the cow). FIGS. 5B and C provide the amplitude and phase of the calculation which are shown schematically in FIG. 5A at the location of the metasurface 503. In some embodiments, the 3D optical reconstruction can be performed both computationally and experimentally. Both reconstructed holograms can provide similar images, including in the details of the simulated laser speckle. The profile of this speckle can depend on both the structure of the cow and the specific random surface phase profile chosen and can be visible because of the coherence between scatterers. In some embodiments, the 3D holographic images generated by the disclosed system cab provide improved resolutions compared to images reconstructed using an LED (e.g., linewidth ˜120 nm centered around 1.55 μm). For example, the laser speckle can be greatly reduced due to the incoherence between scatterers in the imaged generated by the LED system (FIG. 5F).

In certain embodiments, the disclosed system can alter an amplitude and a phase of electromagnetic radiation wavefront at multiple wavelengths. For example, the disclosed system can alter the amplitude and phase of the wavefront at up to three wavelengths simultaneously. The amplitude and phase at each of the wavelengths can be independently controlled by modifying geometric parameter of the disclosed metasurface.

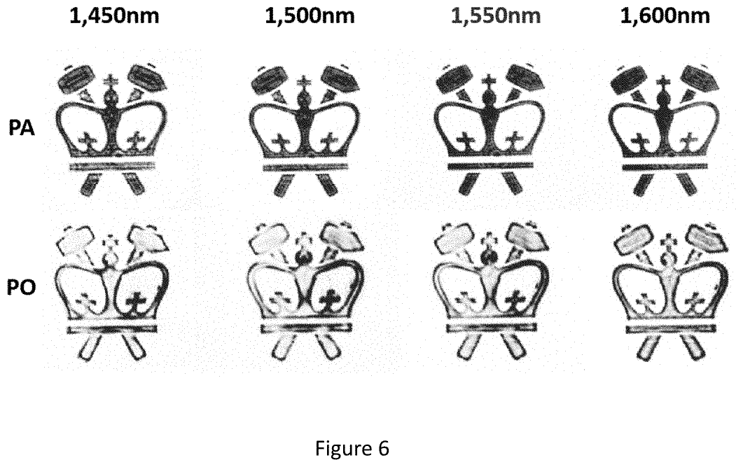

In certain embodiments, the disclosed metasurface can convert an incident electromagnetic radiation using LEDs. The incident electromagnetic which has a wavelength value in a range from about 1450 nm to about 1600 nm can be used to generate holographic images. As shown in FIG. 6 images generated by both the PA and PO metasurfaces show insignificant variation across the bandwidth, which is greater than LEDs in this spectral range.

The disclosed subject matter also provides methods for controlling optical amplitude and phase including providing a substrate with a plurality of meta-units attached on a top surface of the substrate, providing an electromagnetic radiation on a bottom surface of the substrate, wherein the plurality of meta-units is configured to convert the electromagnetic radiation into a target electromagnetic radiation; and filtering the target electromagnetic radiation to remove a non-target electromagnetic radiation. The target electromagnetic radiation can have predetermined optical phase and amplitude. The optical phase and amplitude can be determined by the meta units. In some embodiments, the method can further include modifying a degree of a birefringence angle of the plurality of meta-units to control the optical amplitude. In non-limiting embodiments, the method can further include modifying a degree of an orientation angle of the plurality of meta-units to control the optical phase. In other embodiments, the method can further include generating a holographic image, wherein the holographic image can be a two- or a three-dimensional image.

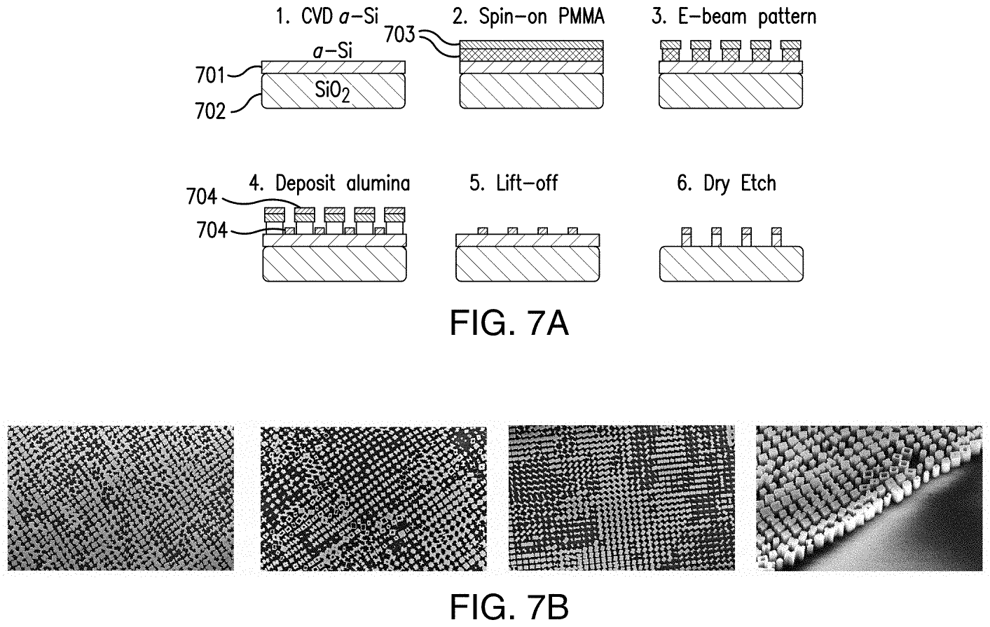

The disclosed subject matter also provides methods for fabricating the disclosed metasurface. An example method, as shown in FIG. 7A, can include performing a chemical vapor deposition (CVD) of amorphous silicon (a-Si) 701 on a clean fused silica wafer 702, spinning of resist layers 703 such as a double-layer PMMA electron-beam resist layer, and patterning using an electron-beam or an optical lithography. The method can further include depositing mask materials 704 such as alumina on the patterned wafer, removing remaining resist layer by lifting off un-wanted alumina, and transferring the mask pattern into the silicon layer by performing reactive-ion etching. In some embodiments, the disclosed fabrication of the metasurface can be Complementary metal-oxide-semiconductor (CMOS) compatible.

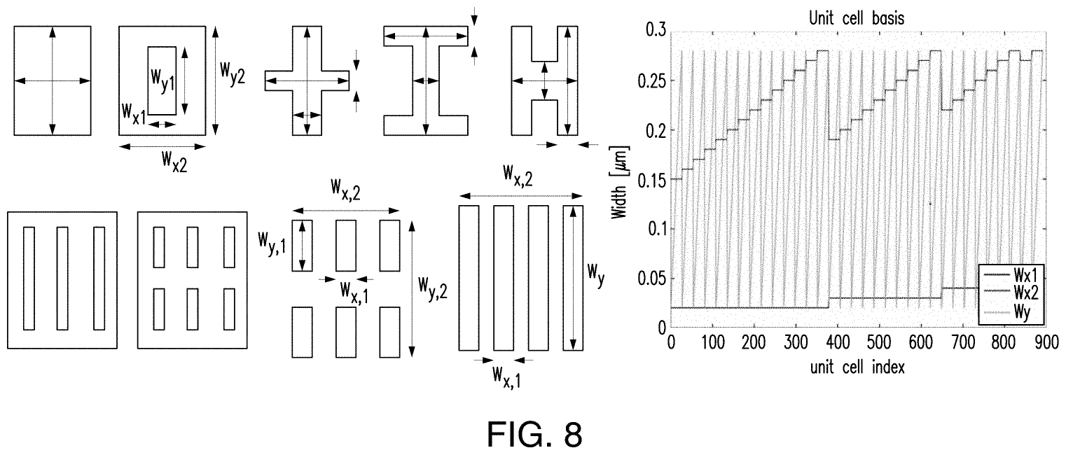

In certain embodiments, the disclose meta units can have various shapes. For example, as shown in FIGS. 7B and 8, each of the meta units can have a rectangular, a triangular, a cross, a ring, and a H shape. Each shape can have a corresponding unit cell basis indexing scheme (FIG. 8, right). Each combination can give different optical properties for each of the three design wavelengths. For example, by widely varying the shape and the orientation of meta units on the substrate, any combinations of birefringent conversion (amplitudes) and relative phases can be achieved. In non-limiting embodiments, an example metasurface can have a center wavelength which can be an opposite handedness radiation compared to non-center wavelengths.

### EXAMPLES

The following examples are offered to more fully illustrate the disclosure but are not to be construed as limiting the scope thereof.

### Example 1: Dielectric Metasurfaces for Complete and Independent Control of Optical Amplitude and Phase

This Example illustrates meta-units with a varying degree of form birefringence and rotation angles to create high efficiency dielectric metasurfaces that control both the optical amplitude and phase.

Here, the example presents a metasurface platform with broadband arbitrary and simultaneous control of amplitude and phase at telecommunications frequencies in transmission mode by varying the conversion efficiency of circularly polarized light of one handedness into the circular polarization of the opposite handedness. The approach employs a constructed dielectric-based meta-unit library that achieves a maximum amplitude approaching unity, which is easily generalizable to visible frequencies without sacrifice to this efficiency. In addition, the fabrication of such dielectric metasurfaces is CMOS compatible. To demonstrate the advantage of simultaneous amplitude and phase control, the performance of computer-generated holograms implemented was compared with both Phase and Amplitude (PA) metasurfaces and holograms implemented with Phase Only (PO) metasurfaces. To demonstrate the ability of PA holography to enable artistically interesting and complex scenes, metasurface holograms were created to generate high-fidelity three-dimensional (3D) holographic scenes.

Certain approach for spatially varying the phase of light is the Pancharatnam-Berry phase, or geometric phase. The geometric phase is so-called because it can be altered by changing a geometric parameter: the orientation of the fast axis of a birefringent material. In the context of metasurfaces, “structural birefringence” is realized with metallic or dielectric scatterers with a different optical response in one in-plane direction compared to the orthogonal in-plane direction.

The operation of such a metasurface on a wavefront is described by using the Jones calculus. In metasurfaces based on the geometric phase, the outgoing polarization state is modified from an incoming one as:

|ψ₂ [symbol] =Γ(−α)MΓ(α)|ψ₁ [symbol] (1)

where |ψ₁ [symbol] and |ψ₂ [symbol] are Jones vectors in a (x,y) basis describing the incoming and outgoing polarization states, respectively, Γ(α) is the 2×2 matrix rotating a unit vector in-plane by an angle α, and M is a matrix accounting for the outgoing amplitudes (Aₒ and Aₑ) and phases (ϕₒ and ϕₑ) for light polarized along the ordinary and extraordinary axes, respectively:

$$M = [ \begin{matrix}{A}_{o} {e}^{i {φ}_{o}} & 0 \\ 0 & {A}_{e} {e}^{i {φ}_{e}}\end{matrix} ] . \qquad ( 2 )$$

Here, the phase accumulated was considered to be due to propagation within a meta-unit, which is a segment of vertically oriented dielectric waveguide, and assume unity transmittance (or forward scattering efficiency, η_{forward}) for both polarizations, which corresponds to Aₒ=Aₑ=1. Therefore, M can be simplified and the relevant phases can be written in terms of the effective refractive indices, nₒ and nₑ, meta-unit height d, and free-space wavevector, k₀=2π/λ corresponding to wavelength λ:

ϕ_{o,e}=k₀n_{o,e}d. (3)

The incident polarization state was considered to be circular polarized light of one handedness (here, left circularly polarized, or LCP, with Jones vector denoted |L [symbol] ) and the signal (outgoing) state to be the opposite handedness, (here, right circularly polarized, or RCP, with Jones vector denoted |R [symbol] ). A polarization filter in the example selects only the RCP component of the outgoing wavefront, yielding a signal, S:

$$S = 〈 R \vert Γ ( - α ) M Γ ( α ) \vert L 〉 = i sin ( \frac{{k}_{0} d ( {n}_{o} - {n}_{e} )}{2} ) exp ( i ( \frac{{k}_{0} d ( {n}_{o} + {n}_{e} )}{2} + 2 α ) ) \qquad ( 4 )$$

This signal is therefore a complex value with both an amplitude and a phase. The amplitude is solely dependent on the sine term, the argument of which depends on the degree of birefringence of the meta-unit, (nₒ−nₑ). This amplitude can also be thought of as the conversion efficiency,

$${η}_{conversion} = sin ( \frac{{k}_{0} d ( {n}_{o} - {n}_{e} )}{2} ) , \qquad ( 5 )$$

from LCP to RCP. It is unity when |n₀−nₑ|d=λ/2 and is zero when the meta-unit has no birefringence, |n₀−nₑ|d=0. Other amplitudes in between are achievable by varying the degree of birefringence between these two extremes.

The choice for metasurfaces based on the geometric phase is to tune the birefringence to the half-wave plate condition, yielding maximum optical amplitude while controlling only the phase of a wavefront through the rotation angle, α. Here, this approach was generalized by creating a meta-unit library utilizing both a and the degree of birefringence of the meta-units, visualized in FIG. 1A. The amplitude is controlled entirely by the degree of form birefringence, while the phase is a sum of the propagation phase,

$$\frac{{k}_{0} d ( {n}_{o} + {n}_{e} )}{2} ,$$

and the geometric phase 2α (Equation 4). In this way both amplitude and phase can be independently controlled.

The action this meta-unit library performs on input circularly polarized light can be schematically visualized by paths along the Poincaré sphere (FIG. 1B). The incident LCP light is placed at the south pole of the Poincaré sphere. The birefringence of the meta-unit determines the “latitude” of the output state on the Poincaré sphere, while the rotation angle α determines the “longitude” on the Poincaré sphere. In this way, incident LCP light can be converted into any polarization state on the Poincaré sphere.

With the addition of a polarization filter (selecting for RCP light and absorbing the remaining LCP light), the output state on the Poincaré sphere can be mapped to amplitude and phase of the RCP light. FIG. 1C schematically depicts the process of reconstructing a PA holographic image: linearly polarized incident light is converted by a quarter-wave plate to LCP light; the wavefront is then modified by the PA holographic metasurface; the RCP component of the transmission through the metasurface is selected by a polarization filter and converted into linearly polarized light, while the remaining unconverted LCP is filtered out.

For an example implementation, an operating wavelength of λ=1.55 μm and a CMOS-compatible platform of amorphous Silicon (a-Si) metasurfaces on a fused silica substrate were examined. The metasurface holograms consist of a square lattice of meta-units with rectangular in-plane cross-sections. The lattice constant of P=650 nm and the meta-unit height of d=800 nm are chosen so that for a large variation of Wₓ and W_{y} (in-plane widths of the meta-units) the forward scattering efficiencies, η_{forward}, for both x and y polarized light are near unity (FIG. 2B). This ensures that Aₒ=Aₑ=1 and that the conversion efficiency is identical to the amplitude of the output signal:

$$\vert S \vert = {η}_{forward} {η}_{conversion} = sin ( \frac{{k}_{0} d ( {n}_{o} - {n}_{e} )}{2} ) . \qquad ( 6 )$$

To find suitable combinations of Wₓ and W_{y} of the target meta-unit library, a set of finite-difference time-domain (FDTD, Lumerical Solutions) simulations are performed and the results are shown in FIGS. 2B and 2C. A contour (dashed lines in FIGS. 2B and 2C) that closely satisfies the condition of η_{forward}=1 was chosen, while providing η_{conversion} that continuously varies from 0 to 1 (FIGS. 2C and 2D). The specific chosen contour has Wₓ=200 nm, and W_{y} varying from 200 nm to 480 nm.

The amplitude (FIG. 2E) and phase (FIG. 2F) of the RCP component of the output is then recorded for each combination of W_{y} and α. Note that the converted amplitude is essentially independent of the orientation angle (FIG. 2E), indicating that the effect of coupling between neighboring meta-units on effective refractive indices n₀ and nₑ is negligible (periodic boundary conditions were used in simulating optical properties of meta-units), and validating the absence of a in Equation 6.

For ease of use, the simulation results are inverted into a set of “look-up” tables (FIGS. 2G and 2H), wherein a desired amplitude and phase combination can be converted to the required geometric parameters, W_{y} and α. The inversion from FIGS. 2E and 2F to FIGS. 2G and 2H demonstrates the arbitrary control of amplitude and phase achieved by the meta-unit library.

To show the complete control of the amplitude and phase, computer-generated holograms (CGHs) were implemented. Three CGHs are demonstrated: the first generates a two-dimensional (2D) holographic images and demonstrates improved fidelity of the image produced with PA holography over those produced with PO holography (FIG. 3); the second is a CGH that creates a simple 3D holographic scene consisting of a collection of points and demonstrates 3D holography by the dependence of the holographic image on the focal plane and observation angle of the imaging optics (FIG. 4); the third CGH demonstrates the faithful reconstruction of a complex 3D holographic scene (FIG. 5).

To generate the 2D CGH, a target image is discretized into dipole sources with amplitudes of 1 (corresponding to the inside area of the logo) and 0 (corresponding to the background), and uniform phase. The interference of these dipole sources is recorded at a distance D=100 μm from the target image, which corresponds to the location of the metasurface that will reconstruct this target image. The result is a complex transmission function, \tilde{τ}(x,y), required at the metasurface plane:

$$\tilde{τ} ( x , y ) = {Σ}_{i , j} \frac{exp ( i {k}_{0} {R}_{ij} ( x , y ) )}{{R}_{ij} ( x , y )} , \qquad ( 7 )$$

where Rᵢⱼ(x,y) is the distance from the (i,j)th dipole source to a position (x,y) on the metasurface plane. Finally, \tilde{τ}(x,y) is normalized: \tilde{τ}ₙₒᵣₘ(x,y)=\tilde{τ}(x,y)/|\tilde{τ}(x,y)|ₘₐₓ. A typical PO implementation can use an iterative algorithm (such as the Gerchberg-Saxton algorithm) to manipulate the phases of the dipoles in order to achieve a \tilde{τ}(x,y) with uniform amplitude, while minimizing the error in the amplitude of the target holographic image. Such is not necessary here, as both the phase and amplitude of the desired holographic image were reproduced, the advantages and disadvantages of which are discussed below. The resulting \tilde{τ}(x,y) for PA and PO are depicted in FIG. 3A and FIG. 3B, respectively.

The devices are fabricated using a CMOS-compatible process, described in detail in the Supporting Information S4. Resulting optical and scanning electron microscopy (SEM) images of the 2D holograms are shown in FIG. 3C and FIG. 3D, respectively. The overall size of each device is 400 μmm×400 μm.

In order to optically reconstruct the holographic images, light from a tunable telecommunications diode laser is sent to a circular polarizer, and then to the metasurface. The scattered light is collected with a 10× near-infrared objective (Mitotoyu) and then passed through a polarization filter and an iris (to clean up the signal) before arriving at the sensor arrays of a near-infrared (InGaAs) camera (Princeton Instruments).

Comparing FIG. 3D to FIG. 3I, it is apparent that the PA implementation reconstructs the target image with greatly improved fidelity compared to the PO implementation. Visually, both the uniformity within the logo area and the contrast of the entire image are improved. To quantify the performance, the mean-squared error (MSE) of the PA and PO results with reference to the ideal image of the logo sampled to the same number of pixels was calculated. The normalized 2D cross-correlation between the target image and the reference is computed to register the translational misalignment. This is then corrected in order to optimally align the target image and the reference. Then, the MSE is calculated by comparing the target (Xᵢⱼ) and reference (Yᵢⱼ) images pixelwise and averaging the result:

$$MSE = \frac{1}{M \times N} {Σ}_{i}^{M} {{Σ}_{j}^{N} ( {X}_{ij} - {Y}_{ij} )}^{2} . \qquad ( 8 )$$

The MSE is calculated to be 3,028 and 6,427 for the PA and PO results, respectively. The lower overall error of the PA compared to the PO is consistent with the visual improvement of the image.

The dependence on observation angles is also measured, and a notable difference between PA and PO implementations is evident. FIG. 3E depicts PA reconstructions at observation angles of 10° and 15°, with MSE values corresponding to 3307 and 4611, and FIG. 3J depicts PO reconstruction at the same angles, with MSE values corresponding to 7985 and 16552. These MSE values suggest that 2D holographic images generated by PA holograms are more robust against deterioration at oblique observation angles.

The incident wavelength is swept from 1450 nm to 1600 nm to explore its effect on the performance of the metasurface holograms. Holographic images generated by both the PA and PO metasurfaces show little variation across this bandwidth, which is greater than the bandwidth of typical LEDs in this spectral range. This therefore confirms that the well-known broadband behavior of the PO metasurfaces based on the geometric phase can be extended to PA metasurfaces based on the geometric phase, and enables holographic methods utilizing LEDs to be explored.

Further improved capabilities of PA holography can be seen in FIGS. 4 and 5, where 3D holography is demonstrated. FIGS. 4A and 4B show \tilde{τ}(x,y) for generating a 3D coil, calculated by discretization of the coil into an array of dipole sources and recording their interference at the metasurface plane. To show the depth of the 3D coil, three focal planes are chosen for reconstruction, depicted in FIG. 4C. The individual dipole sources are discernible at the farthest focal plane of 300 μm, where in the target image the distribution of the dipoles is sparsest, while at the nearest focal plane of 100 μm, they are nearly continuous, and so a solid curve is observed. As seen in FIG. 4D, parallax is demonstrated by changing the viewing angle of the camera (keeping normal incident angle of light onto the metasurfaces), with a recognizable image observed at an angle as high 60° (approximate corresponding focal planes are drawn in FIG. 4D). This verifies the true holographic nature of the experiment: the reconstruction simulates a window into a virtual world populated by the 3D coil.

To demonstrate the ability of PA holography to enable more artistically interesting and complex scenes, a target 3D-modeled cow is converted into a hologram and then reconstructed. FIG. 5A depicts the computer generation of the hologram, computed with a simulation interfering light waves scattered off the 3D surface of the cow. FIGS. 5B and 5C depict the amplitude and phase of the holographic metasurface calculated by this method.

The optical reconstruction is performed both computationally (FIG. 5D) and experimentally (FIG. 5E). The excellent agreement, even in the details of the simulated laser speckle, confirms the versatility of the PA holography to create complex holographic objects. The profile of this speckle depends on both the structure of the cow and the specific random surface phase profile chosen and is visible because of the coherence between scatterers. FIG. 5F shows the example reconstruction using an LED (linewidth ˜120 nm centered around 1.55 μm) instead of a laser, demonstrating the large bandwidth of the meta-unit library. Note that the laser speckle is greatly reduced due to the incoherence between scatterers, as expected.

Certain advantages of PA over PO holographic metasurfaces merit a more detailed discussion. First, it is noted that the version of PO holography used here is not the only method used in PO holography. Instead, as mentioned above, an iterative algorithm such as the Gerchberg-Saxton algorithm can be used to enable a hologram with PO modulation to produce the desired image. Although, strictly speaking, two degrees of control (amplitude and phase) are needed at the metasurface to control the two properties of a scalar wavefront of a holographic scene (amplitude and phase), phase information arriving at the camera sensor (or the human retina) is not recorded, meaning that only one degree of control (e.g., phase) is needed to modulate the one property of the wavefront at the camera sensor (i.e., amplitude).

The Gerchberg-Saxton algorithm can be applied to certain typical PO metasurface holography, which is “lensless” Fourier transform holography. In this form of holography, a holographic image is projected to the far-field (for instance, directly onto a camera sensor) rather than, as in the present paper, being formed through a lens as in a traditional imaging system. In other words, the hologram in the present work generates the wavefront produced by a virtual object, and therefore is effectively a window into a virtual world. The Gerchberg-Saxton algorithm can be generalizable to virtual objects and 3D scenes but can come at the cost of greatly increased computational effort and complexity.

PO holography can have the advantage of an improved power efficiency. This comes from the fact that all of the light incident on the PO hologram contributes to the final image, unlike in PA holography, where amplitude is continuously modulated between 0 and 1, and thus some light is filtered out. The cost of the increased power efficiency in PO holography, however, can be twofold.

First, although phase is not recorded directly, the phase distribution on the optical wavefront can contribute to the visual textures of a virtual object. For instance, a diffuse surface will have random phase, while a glossy surface has some degree of phase uniformity. Therefore, such texture detail is lost (or must be mimicked) by the PO approach, but effortlessly retained in the PA approach, where both the desired phase and amplitude are faithfully reproduced. A related feature of PO holographic images can be a “grainy” appearance, which is not present in our PA holographic images.

Second, a Gerchberg-Saxton-like algorithm can be necessary for the increased power efficiency to not come at the cost of unwanted distortions to the image (FIGS. 3I and 3J). The computational requirements of this can make the problem of arbitrary PO holography (such as an entire 3D scene) difficult and likely impractical to implement, especially in dynamic holography. As shown in FIGS. 4 and 5, this is not necessary in 3D PA holography, which retains more information in the final 3D holographic scene (phase and amplitude) with less computational effort.

FIG. 6 illustrates wavelength dependence of 2D holography comparing phase and amplitude (PA, top row) to phase only (PO, bottom row) holograms for four selected wavelengths. Design wavelength of 1550 nm is highlighted in red, and the overall bandwidth explored (150 nm) is greater than the typical of an LED centered at the operating wavelength.

Certain advantages of PA holography over PO holography extend to the applications of holography that are not simply artistic. For instance, holographic data storage is of considerable interest scientifically and technologically. As a natural consequence of having a larger meta-unit library, more information can be stored per volume with the present approach as compared to traditional PO approaches. A second instance of this advantage could be in security applications, wherein many different holograms that are identical in appearance (that is, amplitude profile) can be made identifiably distinct by encoding a unique phase profile (requiring special equipment to decode).

Complete control of a wavefront at a single frequency can require control of four independent parameters: the amplitude, phase, and polarization state (itself two parameters, corresponding to the position on the Poincaré sphere). Here, the geometric phase was used to control the phase of the signal, with small corrections for varying propagation phase. However, meta-units combining geometric phase and widely varying propagation phase can achieve a given phase in an infinite number of ways. Here, birefringence (that is, the difference of propagation phase for the extraordinary and ordinary polarizations in a meta-unit) was tested in order to control the output state on the Poincaré sphere. More degrees of freedom can be taken advantage of, evident for instance in the many contours selectable in FIG. 2B-2D (each contributing a different average propagation phase). These degrees of freedom can allow amplitude and phase control to be extended to up to three wavelengths simultaneously.

The disclosed subject matter provides a powerful extension of the long-employed geometric-phase metasurfaces, opening up a degree of control over an optical wavefront useful in many applications, and offers a robust and generalizable method towards realizing the primary promise of metasurfaces: to manipulate an optical wavefront at will.

### Example 2: Characterization of Dielectric Metasurfaces

This Example illustrates characterization of dielectric metasurfaces.

FIG. 7 illustrates example fabrication process flow: 1. Chemical vapor deposition of amorphous Silicon (a-Si) 701. 2. Spinning of resist layers 703. 3. Exposure by electron-beam or optical lithography and subsequent chemical development. 4. Deposition of mask material 704. 5. Dissolution of remaining resist layer: “lifting-off” the un-wanted mask material. 6. Transfer of the mask pattern into the silicon layer by reactive-ion etching. FIGS. 7B and 8 provide exemplary metasurface generated by the disclosed fabrication methods.

### Derivation of Amplitude and Phase of RCP Output from a Meta-Unit

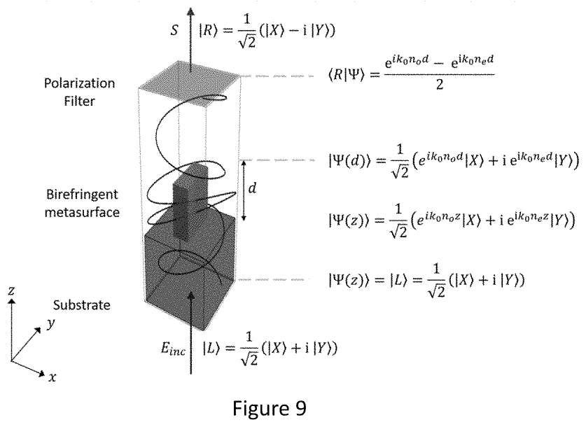

FIG. 9 depicts the evolution of the Jones vector through a meta-unit for the simplified case of α=0. To include the effects of α, incident light is defined as, E_{inc}=|L [symbol] , coming from the substrate side, with definitions of left-hand circularly polarized light (|L [symbol] ) and right-hand circularly polarized light (|R [symbol] ) in terms of linear polarization basis, (|X [symbol] , |Y [symbol] ):

$$\begin{matrix}\vert X 〉 = [ \begin{matrix}1 \\ 0\end{matrix} ] , & ( 9 ) \\ \vert Y 〉 = [ \begin{matrix}0 \\ 1\end{matrix} ] , & ( 10 ) \\ \vert L 〉 = \frac{1}{\sqrt{2}} ( \vert X 〉 + i \vert Y 〉 ) , & ( 11 ) \\ \vert R 〉 = \frac{1}{\sqrt{2}} ( \vert X 〉 - i \vert Y 〉 ) & ( 12 )\end{matrix}$$

The state of light as a function of propagation distance z through the meta-unit, |Ψ(z) [symbol] can be written as:

$$\begin{matrix}\vert Ψ ( z ) 〉 = Γ ( - α ) M ( z ) Γ ( α ) \vert L 〉 , \\ with & ( 13 ) \\ M ( z ) = [ \begin{matrix}{A}_{o} {e}^{i {φ}_{o} ( z )} & 0 \\ 0 & {A}_{e} {e}^{i {φ}_{e} ( z )}\end{matrix} ] , & ( 14 ) \\ {φ}_{o} ( z ) = \frac{2 π}{λ} {n}_{o} z , & ( 15 ) \\ {φ}_{e} ( z ) = \frac{2 π}{λ} {n}_{e} z , \\ and & ( 16 ) \\ Γ ( α ) = [ \begin{matrix}cos ( α ) & - sin ( α ) \\ sin ( α ) & cos ( α )\end{matrix} ] & ( 17 )\end{matrix}$$

Taking Aₒ=Aₑ=1, this becomes:

$$\vert Ψ ( z ) 〉 = [ \begin{matrix}cos ( α ) & sin ( α ) \\ - sin ( α ) & cos ( α )\end{matrix} ] \times [ \begin{matrix}{e}^{i {φ}_{o} ( z )} & 0 \\ 0 & {e}^{i {φ}_{e} ( z )}\end{matrix} ] \times [ \begin{matrix}cos ( α ) & - sin ( α ) \\ sin ( α ) & cos ( α )\end{matrix} ] \times \frac{1}{\sqrt{2}} [ \begin{matrix}1 \\ i\end{matrix} ] , \qquad ( 18 )$$

which can be simplified to:

$$\vert Ψ ( z ) 〉 = \frac{{e}^{i \frac{{φ}_{o} ( z ) + {φ}_{e} ( z )}{2}}}{\sqrt{2}} [ \begin{matrix}cos ( \frac{{φ}_{o} ( z ) - {φ}_{e} ( z )}{2} ) + i sin ( \frac{{φ}_{o} ( z ) - {φ}_{e} ( z )}{2} ) {e}^{2 i α} \\ i ( cos ( \frac{{φ}_{o} ( z ) - {φ}_{e} ( z )}{2} ) - i sin ( \frac{{φ}_{o} ( z ) - {φ}_{e} ( z )}{2} ) {e}^{2 i α} )\end{matrix} ] \qquad ( 19 )$$

The action of the polarization filter is to select the RCP component of |Ψ(z) [symbol] after a propagation distance of z=d (i.e., height of the meta-unit). The output from the polarization filter, S, is therefore calculated by the inner product of |R [symbol] and |Ψ(d) [symbol] :

$$S = 〈 R \vert Ψ ( d ) 〉 = {\frac{1}{\sqrt{2}} [ 1 - i ]}^{*} \times \vert Ψ ( z ) 〉 \qquad ( 20 )$$

which simplifies to:

$$S = i sin ( \frac{{k}_{0} d ( {n}_{o} - {n}_{e} )}{2} ) exp ( i ( \frac{{k}_{0} d ( {n}_{o} + {n}_{e} )}{2} + 2 α ) ) \qquad ( 21 )$$

### Meta-Unit Library as a Polarization State Converter

$${η}_{conversion} = \vert S \vert = sin ( \frac{{k}_{0} d ( {n}_{o} - {n}_{e} )}{2} )$$

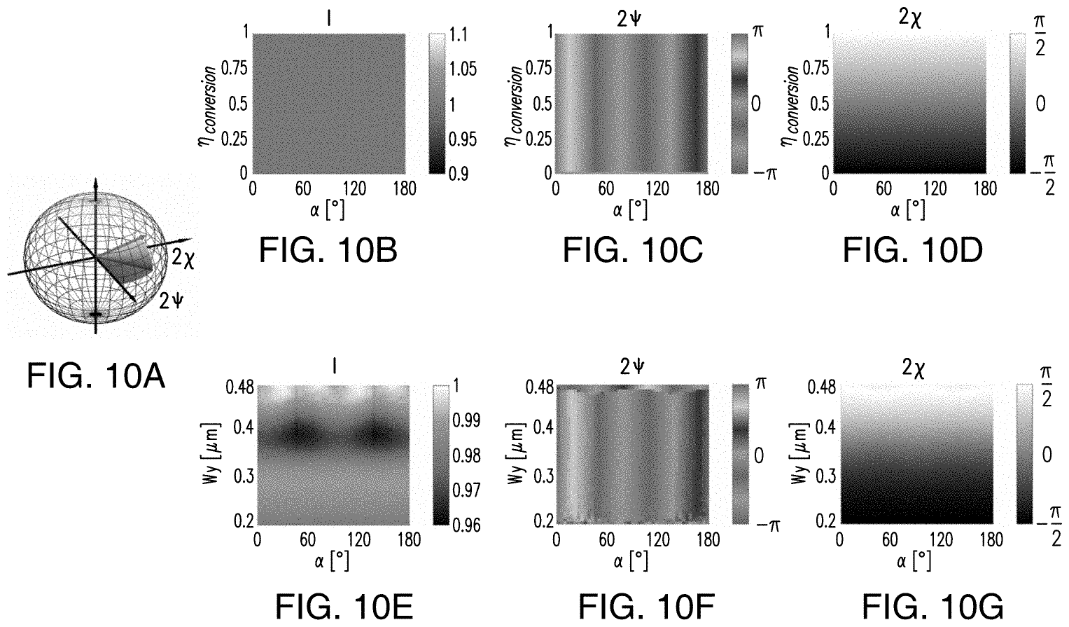

is defined as a measure of the birefringence of a given metal-unit. FIG. 10 depicts the relationship between the output position on the Poincaré sphere and the values of η_{conversion} and α. The longitude, 2ψ, and latitude, 2χ of the Poincaré sphere define the two degrees of freedom determining the polarization state, and along with the intensity, I, are the spherical coordinates corresponding to the Stokes parameters of polarized light:

S₀=I (22)

S₁=I cos(2ψ)cos(2χ) (23)

S₂=I sin(2ψ)cos(2χ) (24)

S₃=I sin(2χ) (25)

Complete control over the output polarization state therefore requires independent control of ψ and χ. As depicted in FIGS. 10B-D, equation 19 predicts that a meta-unit library with η_{conversion} spanning from 0 to 1, along with α ranging from 0 to 180°, will be able to take incident circularly polarized light (here, LCP) into any output polarization state with unity power efficiency. Full-wave simulations (FIGS. 10E-F) confirm this, with FIG. 10E demonstrating that the efficiency is maintained above 96% for all meta-units. In both cases, it is evident that independent control of ψ and χ are achieved through α and η_{conversion}, respectively.

### Look-Up Table Construction

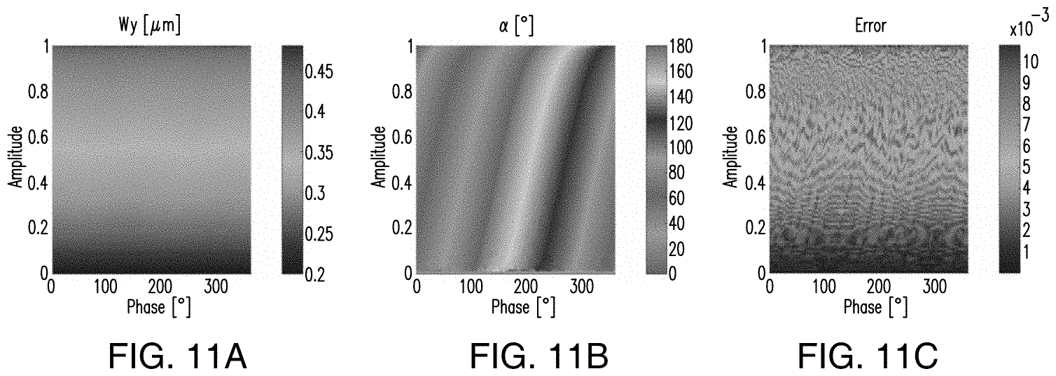

The process of constructing the look-up table is as follows: First, the meta-unit library simulations (FIGS. 2E and F) are interpolated in order to provide a library that is more continuous. This is done in lieu of additional full-wave simulations to save time, and is justified by the monotonic behavior shown in the discrete set of simulations performed. Second, a table of each combination of target phases, ϕ, in the range of (0,360°) and amplitudes, A, in the range of [0,1] is generated. The entries in this table take the form of a phasor: Ae^{iϕ}. Third, for each entry in the table, the target phasor (Aₜe^{iϕ}^{ₜ}) is compared to the achievable phasors in the interpolated meta-unit library. The geometrical parameters for the choice with minimal error is recorded along with the corresponding error (error=|Ae^{iϕ}−Aₜe^{ϕ}^{ₜ}|). The results are shown in FIG. 11. FIGS. 11A and B depict the look-up table constructed and FIG. 11C depicts the corresponding error for each entry. The maximum error is roughly 0.011 (or 1.1%).

### Optical Characterization Set-Up

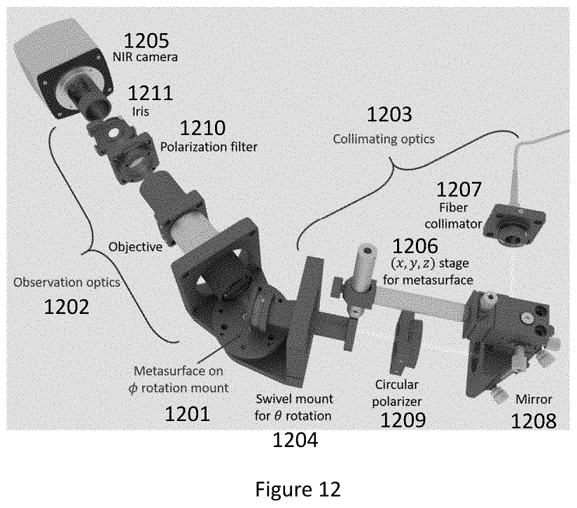

FIG. 12 schematically depicts the setup used for example reconstruction of holographic scenes by our metasurface holograms. A set of collimating optics passes circularly polarized light to the metasurface 1201. Light is collected and analyzed by the observation optics 1202. The observation optics 1202 and collimating optics 1203 are linked by a swivel mount 1204 allowing a varying angle, θ, between the two. Due to the weight of the near-infrared (NIR) camera 1205 (Nirvana InGaAs camera, Princeton Instruments), the observation optics is stationary, and the collimating optics are moved to change θ. The metasurface is aligned to the axis of rotation of the swivel mount by an (x,y,z) dovetail stage system 1206 attached to the collimating optics. In this way, when θ is changed, the illumination condition is fixed.

The collimating optics include a fiber collimator 1207 passing input laser light from a tunable laser source to a redirecting mirror 1208 and then to a circular polarizer 1209 before finally illuminating the metasurface from the substrate side. These collimating optics are all linked together in a cage system (cage parts are omitted for clarity in FIG. 12) to the swivel mount. The metasurface is mounted on a rotation mount for control of an additional Euler angle, ϕ.

The observation optics include an infinity-corrected 10× objective collecting light scattered by the metasurface, which passes light through a tube lens to sharpen the image, and then a polarization filter 1210 and iris 1211 (to help reduce unwanted light from reaching the camera sensor) and finally to the NIR camera.

Note that the circular polarizer and polarization filter are the same part with opposite chirality and orientation: a polymer polarizer cemented to a polymer quarter waveplate aligned at a ±45° angle to the fast axis of the waveplate. Light incident on the first instance of this part along the optical path (labelled the “circular polarizer”) hits the polarizer side first, and then the resulting linear polarized light is converted by the quarter waveplate portion into circularly polarized light, regardless of the polarization outputted by the fiber collimator. The “polarization filter” is the the opposite handedness of the circular polarizer, and oriented such that the quarter waveplate is illuminated first. Light of the opposite handedness than that created by the circular polarizer is therefore converted by the quarter waveplate to linear polarized light that passes through the polarizer side, while light with the same handedness is converted by the quarter waveplate to the orthogonal linear polarization, which is absorbed by the polarizer.

### Wavelength Dependence of 2D Holograms

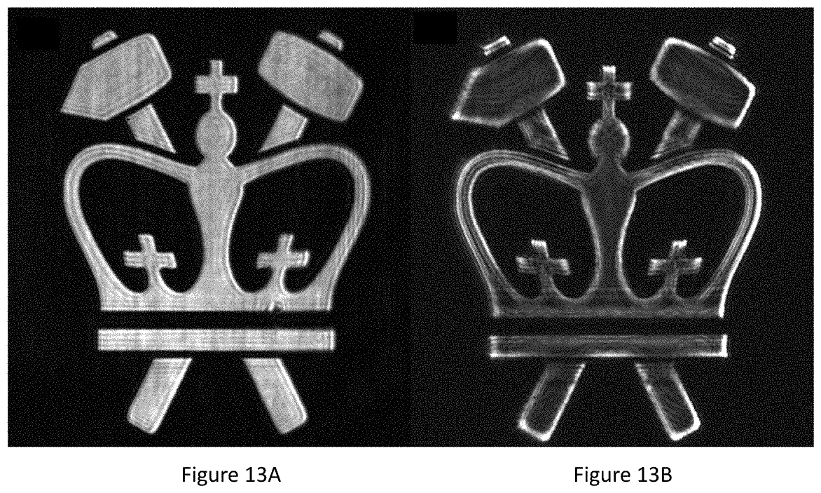

To test the dependence on wavelength of the example reconstruction of 2D holographic images, a supercontinuum source (NKT Photonics) is passed through a monochromator (Horiba) and then passed to the optical setup with an optical fiber. The rest of the experiment is as depicted above. Note that the circular polarizer (ThorLabs) is designed for the operating wavelength of 1,500 nm, and has roughly 4% error in phase retardation at 1,500 nm and 1,600 nm and 8% error at 1,450 nm, which can contribute to the degradation of the image slightly. 1,650 nm is beyond the bandwidth of the fiber used for this experiment. Notwithstanding the contributions of these errors, the bandwidth of the metasurface holograms is evidently comparable to the well-known broadband behavior of metasurfaces based on the geometric phase, as shown in FIG. 6. Images are as recorded, without flipping the logo horizontally to match the desired orientation. Lager 2D holograms are depicted in FIG. 13. Larger holograms were fabricated and tested in addition to the ones shown in the main text, with sizes of 750 μ×750 μm. FIG. 13 shows the results for PA and PO holograms with larger holograms fabricated with sizes of 750 μm×750 μm. Interference from a stray light (likely from back reflections) is apparent especially on the right in Holographic image produced by the phase and amplitude hologram (FIG. 13A).

### Computer Generation of a Complex 3D Object

To generate the 3D hologram, a virtual scene was prepared wherein the cow was illuminated by an incoming plane wave. A hologram plane was located in front of the cow, and compute at every hologram pixel the optical phase and amplitude, which is a superposition of light waves reflected by the cow's surface region that is not occluded from the incident light. The phase and amplitude at each hologram pixel were computed using Monte Carlo integration over the cow mesh: points over the surface mesh were sampled, and the dipole propagation from the sampled points to the pixel position was computed. In order to account for the rough surface of the cow, the phase delay between each surface point and the pixel position were perturbed. The output of this simulation process was a 2D array of complex numbers, describing the phase and amplitude distribution over the hologram.

### Simulation of Optical Reconstruction

When reconstructing the 3D holographic cow, the CGH was considered as an input “transparency” placed behind a virtual lens. In this simulation setup, the CGH serves as a spatial light modulator that shapes the phase and amplitude of the output light field at every of its pixels as if the light is reflected by the cow. Then the light field intensity received on an imaging plane placed in front of the lens is calculated. The imaging plane is selected to focus on a plane that is near the head of the cow. The simulation setup enables a fast computation of the light intensity on the imaging plane using Fourier transformation.

### Example 3: High-Efficiency Amplitude-Phase Modulation Holograms Based on Dielectric Metasurfaces

This Example illustrates a high-efficiency dielectric metasurface with continuous and arbitrary control of both amplitude and phase. Advantages of complete wavefront control are demonstrated by comparing amplitude-phase modulation metasurface holograms to phase-only metasurface holograms.

### Metasurface Design

Arbitrary phase control is achieved to exploit the phase change associated with the change of optical polarization (i.e., Pancharatnam-Berry phase, or ϕPB). In this method, the metasurface is made up of building blocks (meta-units) that convert incident circularly polarized (CP) light to CP light with opposite handedness via structural birefringence. The converted light, with right circular polarization (RCP), is the signal, and the unconverted light, with left circular polarization (LCP), is filtered out by a polarizer. The signal carries a geometric phase of

ϕ_{signal}=ϕ_{PB}=2α (26)

where a is the orientation angle of the fast axis of the birefringent meta-unit. The amplitude of the signal is dependent on the forward scattering efficiency flscatt of the meta-units and the efficiency LCP->RCP of the meta-units in changing the handedness of the CP incident light:

A_{signal}=η_{scatt}×η_{LCP->RCP}. (27)

Metasurface holograms with the highest efficiency can be achieved when η_{scatt} for all the meta-units approaches unity. By varying the degree of birefringence of the meta-units (by varying the geometry), any conversion efficiency from LCP to RCP can be achieved. In this way, arbitrary control of phase and amplitude of the signal is achievable.

Using a platform of amorphous silicon (a-Si) on a fused quartz substrate, the parameter space were tested (FIG. 14A) of rectangular dielectric nanopillars 1401 and select a basis of meta-units 1402 with near-unity ηscatt, but varying ηLCP->RCP (FIGS. 14B and 14C). In a practical implementation, the height, H, and the inter-element spacing, P, are fixed at H=800 nm and P=650 nm for an operating wavelength of λ=1550 nm. The meta-units in FIG. 14D comprise a unit cell basis of continuously varying ηLCP->RCP. Full-wave simulations of the forward-scattered RCP light as a function of the orientation angle, a, and position along the white contour in FIGS. 14B and 14 confirm the achievement of continuous and independent control of the phase and amplitude response of the signal. FIG. 12D shows full conversion efficiency 1403 while machining the scattering efficiency 1404.

### Example Results

Two CGHs were calculated using a target image located at a distance D=50 μm behind the metasurface, keeping uniform phase at the image plane. In the first CGH, the amplitude information was retained (PA), and in the second the amplitudes were set to unity (PO) in order to compare two holograms with correct image plane phase. This method of PO holography is chosen instead of using an iterative algorithm such as the Gerchberg-Saxton algorithm, which reduces amplitude errors at the cost of introducing phase errors (limiting the apparent texture to only diffuse surfaces). In both CGHs, the size of the hologram is roughly 150×150 μm².

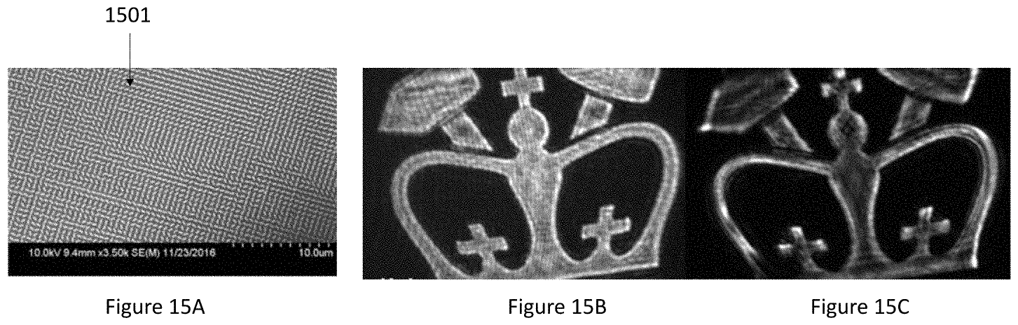

The CGHs were fabricated using electron-beam lithography to pattern an alumina (Al2O3) mask, and reactive ion etching to transfer the pattern 1501 to the a-Si layer (see FIG. 15A). Characterization was performed by sending the output from a supercontinuum source (NKT Photonics) through a diffraction grating monochromator (Horiba Scientific) and Unpolarized-to-LCP polarizer (ThorLabs) to the metasurface. The signal was collected by a 20× objective lens and sent to a near-infrared camera (Princeton Instruments) after being filtered by a RCP-to-Linear polarizer (ThorLabs). A comparison of the resulting images (FIGS. 15B and 15C) confirms the advantages of PA over PO in achieving high-fidelity holographic images, particularly in reduction of signal variance within the logo boundaries.

Low-loss dielectric metasurface-based holograms with complete phase and amplitude control operating in the near-infrared and working in the transmission mode are demonstrated. In particular, the phase of the pixels of the metasurface holograms can continuously cover the entire 2π range, and the amplitude of the pixels can independently span from 0 to ˜100% of the incident amplitude. Unlike metallic scatters, the design principles are easily extendable to the visible range. The improvement to the quality of images created by 2D PA holograms as compared to PO holograms are also demonstrated.

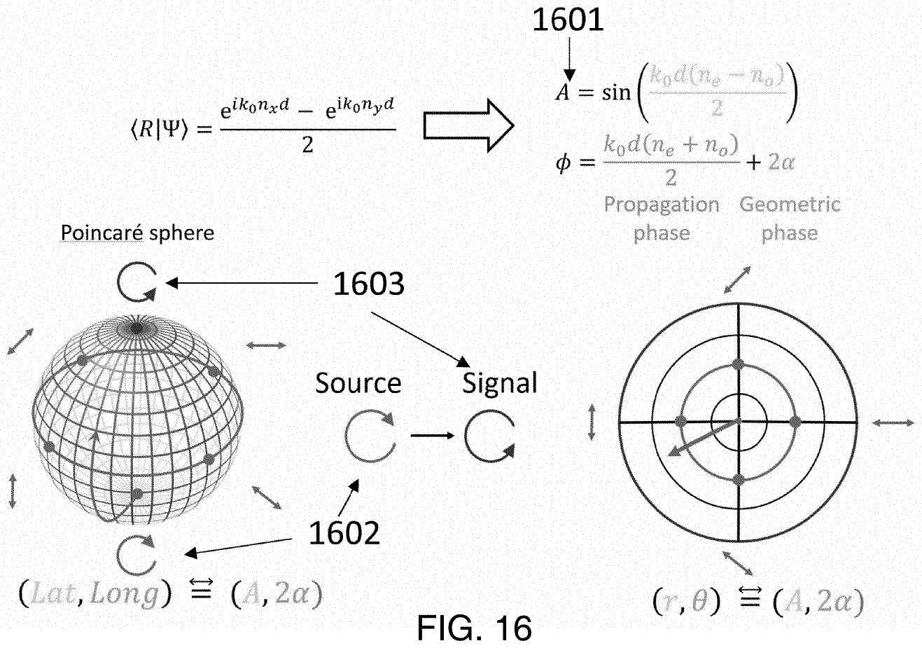

FIG. 16 provides amplitude and phase of final state of outgoing wavefront. The final state is the right-handed circularly polarized component 1603 of the output of the metasurface, which is described by the difference of two exponentials 1601. The source 1602 is the left-handed circularly polarized light. This difference is a complex value, with an amplitude and a phase, parameterized by (1) the index along the extraordinary optical axis, nₑ, (2) the index along the ordinary optical axis, nₒ, and (3) the angle, α, between the extraordinary optical axis and the local y-axis. This overall polarization conversion and filtering can be mapped to a path along the Poincaré sphere, and more easily visualized by projecting the sphere to polar coordinates (which map to the amplitude and Pancharatnam-Berry (or “Geometric”) component of the phase).

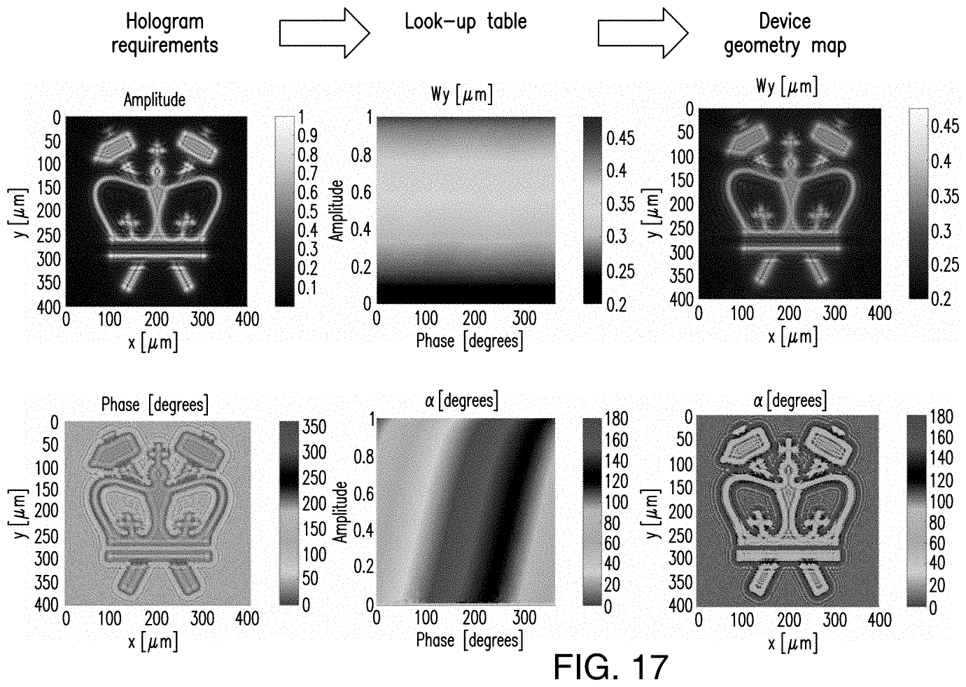

FIG. 17 shows example implementation of a device employing the unit cell library achieved. (Left) Amplitude and phase of a computer-generated hologram. (Middle) Look-up tale for the geometric parameters need to supply any amplitude/phase combination. (Right) Resulting map of device geometry, to be fabricated using CMOS-compatible nanofabrication techniques.

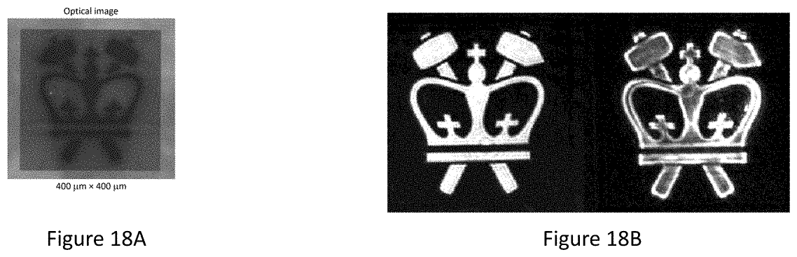

FIG. 18 shows example fabricated devices. FIG. 18A is a dark-field optical image of a metasurface hologram. 18B shows a reconstructed holographic image using both amplitude and phase (left), illustrating improved uniformity and fidelity of the reproduced image, compared to the same target holographic image reconstructed from a device that uses a metasurface that controls only phase (Left).

FIG. 19 provides example fully-3D amplitude and phase holographic images with no phase compensation algorithms used (such as Gerchberg-Saxton algorithm). FIG. 19A is a simulation of holographic reconstruction of a 3D holographic cow. FIG. 19B is an example holographic reconstruction of the 3D holographic cow with a laser diode at λ=1,550 nm.

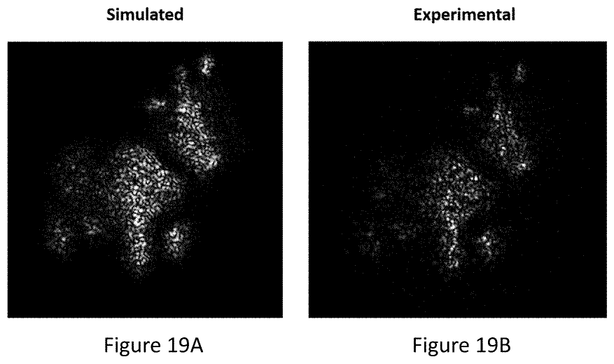

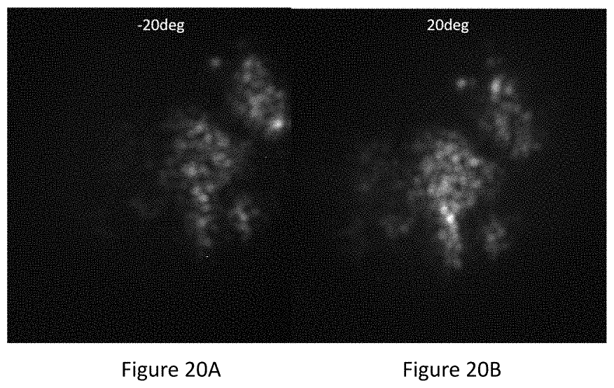

FIG. 20 shows an example reconstruction of the 3D holographic cow with LED excitation, showing parallax. LED excitation demonstrates the broadband nature of the amplitude-phase control and the corresponding utility in holographic reconstruction without coherent sources. FIG. 20A illustrates that more of the broad side of the cow are illustrated at the −20-degree observation angle compared to straight-on observation. FIG. 20B shows that more of the front side of the cow are illustrated at the 30-degree observation angle compared to straight-on observation.

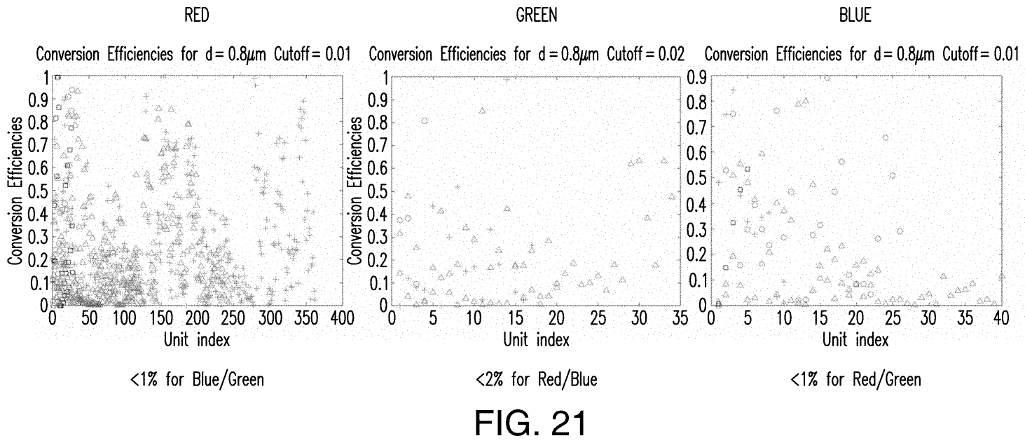

FIG. 21 provides an example multiplexing sub-set of the full library. Example multiplexing sub-set of the full library. Shown here are unit cells whose optical response for red light (Left) have any combination of amplitude and phase (controlled by orientation angle, not shown here) but less than 1% amplitude for both of the other design wavelengths (Blue and Green). (Middle) and (Right) show the existence of unit cells with the equivalent functionality for the other two wavelengths (Green and Blue, respectively). This proves arbitrary amplitude/phase control for three wavelengths simultaneously, at a subwavelength spatial resolution.

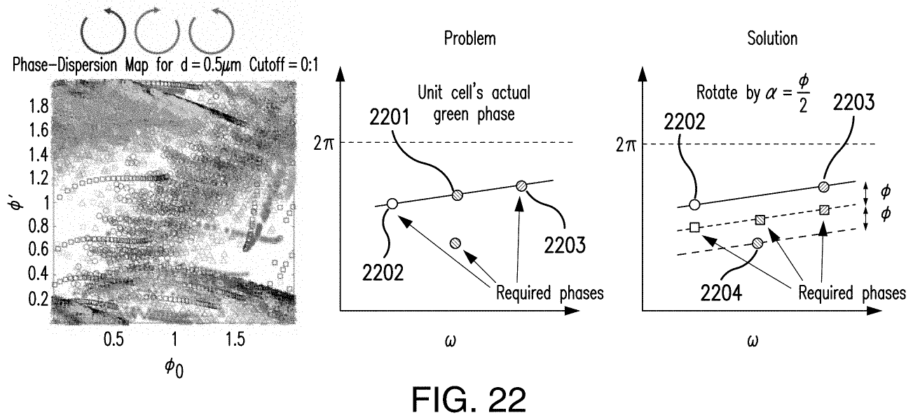

FIG. 22 shows multi-wavelength phase control without multiplexing: Green light is oppositely handed compared to Red/Blue. Phase-dispersion diagram due to propagation phase can be filled (each marker corresponds to a different unit cell geometry) with previously shown unit cell library. In this scheme, any combination of phase for blue light (y-axis) and phase for red light (x-axis) can be achieved without using the geometric parameter (Left). The phase of green light 2201 is fixed for each combination of red/blue phase 2202 and 2203, not allowing separate control of green (Middle). If green light has opposite handedness of circular polarization 2204 compared to red 2202 and blue light 2203, the geometric parameter in conjunction with the propagation phase can be used to add the green operating wavelength (Right). Therefore, arbitrary phase profiles can be created separately for the three wavelengths using a single unit cell. Accordingly, an example metasurface can have a center wavelength which can be an opposite handedness radiation compared to non-center wavelengths.

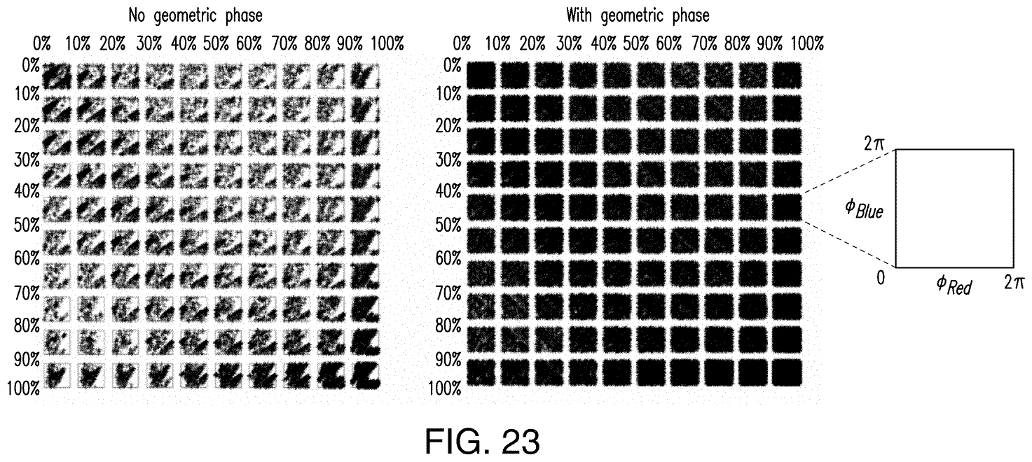

FIG. 23 illustrates amplitude and phase control of two-wavelength without geometric phase being used (Left, only phase) and with geometric phase (Right). The set of 10×10 boxes represent the phase-phase map for blue and red light (Right). Each box corresponds to a different amplitude bin, with “blue” light (here, λ=940 nm) increasing in amplitude from left to the right, and red (here, λ=1,650 nm) increasing from top to bottom. Black dots represent a calculated unit cell with the corresponding combination of amplitude and phase for blue and red light. The filling of every box represents the complete control of amplitude and phase for both blue and red light simultaneously. Note that employing the geometric phase is necessary for this to be accomplished.

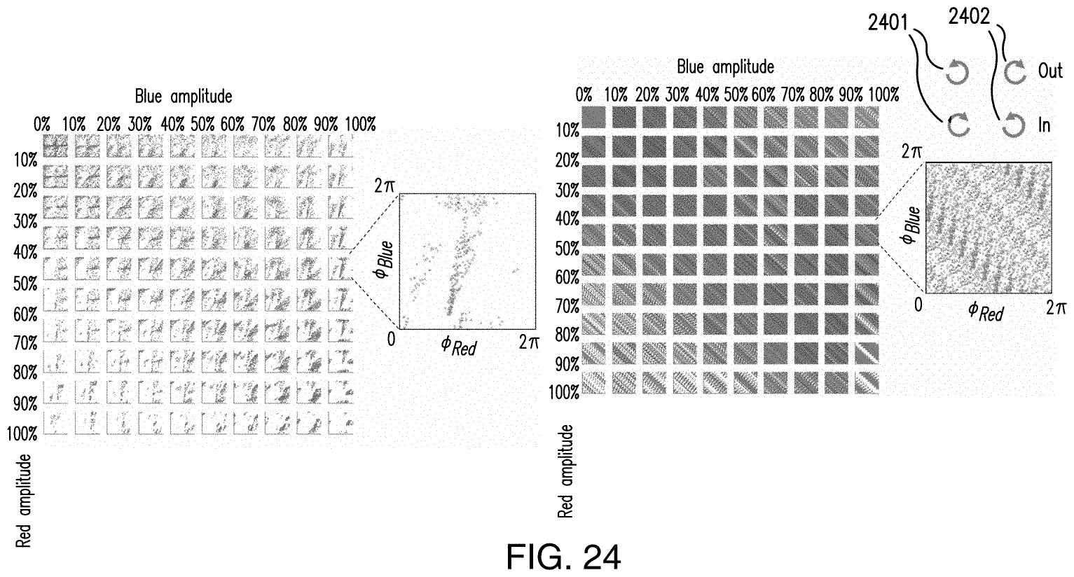

FIG. 24 illustrates a two-wavelength amplitude and phase control (Left) without geometric phase being used, (Right) with geometric phase. Insets illustrates a set of 10×10 boxes which represents the phase-phase map for blue and red light. Markers indicate type of meta-unit in disclosed final meta-unit library. Handedness of input and output states of each color (Red 2401, Blue 2402) are chosen to be opposite each other (Right inset).

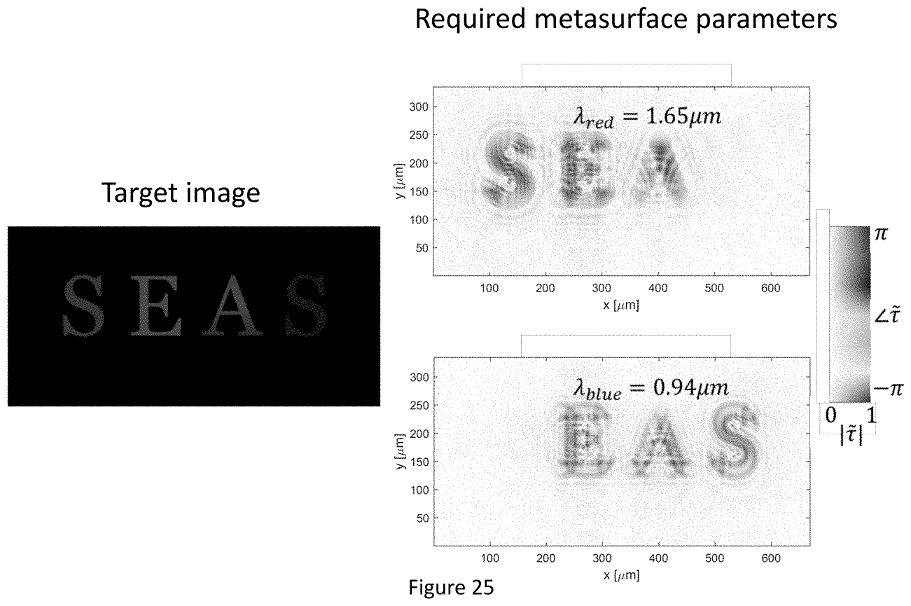

FIG. 25 provides exemplary two-color holograms. A two-color target image (Left) can be used to calculate the required amplitude and phase at two wavelengths of light (Right).

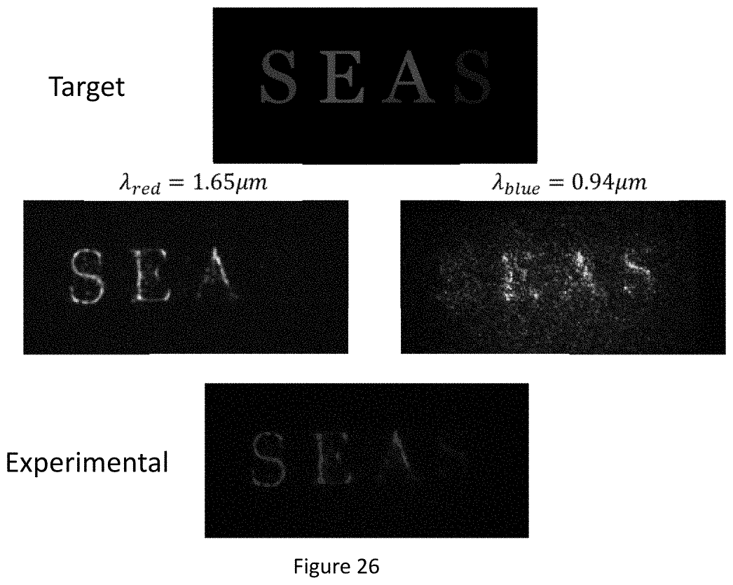

FIG. 26 shows exemplary two-color hologram reconstruction. A two-color target image (Top) can be reconstructed by a tunable laser system at each wavelength separately (Middle) and combined to create a final image (Bottom).

In addition to the various embodiments depicted and claimed, the disclosed subject matter is also directed to other embodiments having other combinations of the features disclosed and claimed herein. As such, the particular features presented herein can be combined with each other in other manners within the scope of the disclosed subject matter such that the disclosed subject matter includes any suitable combination of the features disclosed herein. The foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the systems and methods of the disclosed subject matter without departing from the spirit or scope of the disclosed subject matter. Thus, it is intended that the disclosed subject matter include modifications and variations that are within the scope of the appended claims and their equivalents.

What is claimed is:

1. A system for controlling an optical amplitude and an optical phase of incident electromagnetic radiation, comprising:
a substrate; and
a plurality of meta units, attached to a top surface of the substrate and configured to convert the incident electromagnetic radiation into a target electromagnetic radiation by modifying both optical amplitude and phase.

2. The system of claim 1, wherein the electromagnetic radiation is a circularly polarized electromagnetic radiation of one handedness.

3. The system of claim 2, wherein the electromagnetic radiation is a left circularly polarized electromagnetic radiation or a right circularly polarized electromagnetic radiation.

4. The system of claim 1, wherein the target electromagnetic radiation is a polarized electromagnetic radiation with a predetermined polarization state.

5. The system of claim 1, wherein each of the plurality of meta-units has different degree of a birefringence and/or a rotation angle to form a dielectric metasurface.

6. The system of claim 5, wherein the optical amplitude is altered by modifying a degree of the birefringence.

7. The system of claim 5, wherein the optical phase is altered by modifying a degree of the orientation angle.

8. The system of claim 7, wherein a range of the degree of the orientation angle is from about 0° to about 180°.

9. The system of claim 1, further comprising a filter, wherein the filter is configured to select the target electromagnetic radiation and absorb a non-target electromagnetic radiation.

10. The system of claim 1, wherein the system generates a two- or a three-dimensional holographic image.

11. The system of claim 1, wherein the optical amplitude and the optical phase is independently controlled by the system at optical frequencies.

12. The system of claim 1, wherein the system is configured to simultaneously alter the optical amplitude and the optical phase of electromagnetic radiation at multiple wavelengths.

13. The system of claim 1, wherein the substrate includes a complementary metal oxide semiconductor (CMOS) compatible material.

14. The system of claim 1, wherein the CMOS compatible material is amorphous silicon.

15. A method for controlling an optical amplitude and an optical phase of incident electromagnetic radiation, comprising:
providing a substrate with a plurality of meta-units attached on a top surface of the substrate;
providing the incident electromagnetic radiation on the substrate, wherein the plurality of meta units is configured to convert the incident electromagnetic radiation into a target electromagnetic radiation by modifying both optical amplitude and phase; and
filtering the target electromagnetic radiation to remove a non-target electromagnetic radiation.

16. The method of claim 15, wherein an optical phase and optical amplitude are altered by modifying a geometry parameter of the meta units.

17. The method of claim 15, further comprising modifying a degree of a birefringence angle of the plurality of meta-units to control the optical amplitude.

18. The method of claim 15, further comprising modifying a degree of an orientation angle of the plurality of meta-units to control the optical phase.

19. The method of claim 15, further comprising generating a holographic image.

20. The method of claim 19, wherein the holographic image is a two- or a three-dimensional holographic image.
